(19) United States
(12) Patent Application Publication
(10) Pub. No.: US 2006/0230385 A1
(43) Pub. Date: Oct. 12, 2006

(54) METHOD FOR DISPLAYING PROGRAM PROFILING, SOFTWARE DEVELOPMENT PROGRAM WITH PROFILING DISPLAY AND PHYSICAL STORAGE MEDIUM WITH SOFTWARE DEVELOPMENT PROGRAM

(76) Inventors: I-Lang Chang, Taipei (TW); Yu-Chi Chuang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/907,680

(22) Filed: Apr. 12, 2005

(51) Int. Cl. G06F 9/44

(52) U.S. Cl. 717/127

(57) ABSTRACT

A method for displaying profiles of a software development environment, a software development program with such profiling display and a physical storage medium device with such software development program is provided. The method includes executing a program code in a software development environment to generate a corresponding profile. Then, according to the contents of the profile, a partial execution result is displayed in the form of a graphical figure in a portion of the corresponding program code. The graphical figure is visually displayed in reference to the profiling results of the partially executed program code, for determining the executing result.

### BACKGROUND OF THE INVENTION

1. Field of the Invention

The present invention generally relates to a method of accessing data in program profiles and a viewing function, and more particularly to a method for displaying program profiles, a software development program with such profiling display and a physical storage medium with such software development program.

2. Description of the Related Art

In the course of an application program development, a programmer needs to know how much time is used for each part of the program to be executed and how much system resources are consumed to locate the most time-consuming part in the program, called a hotspot, then optimize it for better performance. In order to obtain information of the hotspot, a common way is to execute program profiling, which records the address of executing the program and integrates the debug information, to derive the execution frequency or time of each section of the program.

In prior art, the following methods are used to record addresses of executing the program.

1. The coding device inserts appropriate code fragments, which records the program execution addresses and save them in a file or memory for later analysis.

2. The application program runs on a software simulator that records program execution addresses and saves them for later analysis.

3. The application program runs on a hardware processor equipped with PC Tracing function to record and save the program executing addresses for later analysis using related functions of PC Tracing.

Although the above methods are capable of generating profiling results, the current method of displaying the profiles still have several flaws and inconveniences. The profile analyzing program of prior art is generally independent of the debugging or developing environment and will display the profiling result of program executing frequency and time in separate charts. A programmer would have to check the results and read the original source code at the same time, while switching between two different programs in order to make desired tunings, which is strenuous. In a relatively novel integrated software development environment, profiling results are displayed in the form of numerals in the beginning of each source code line. However, to determine the magnitude of numerals in a vast amount of source codes or recognize the profiling result in a long-lasting scroll of program codes cannot be achieved by intuition.

### SUMMARY OF THE INVENTION

The present invention provides a method for displaying program profiling in a software development environment and a software development program which is equipped with such profiling display provided, so that profiling results are visually shown in the source code editing window in the software development environment.

The present invention also provides a method for displaying program profiling in the software development environment and a software development program with such profiling display provided, in which a ruler that indicates the range of graphical bars is located in the source code editing window in the software development environment to facilitate the viewing of profiling results.

The present invention offers a method for displaying program profiling in the software development environment and a software development program with such program profiling display provided. The method for accessing the data of the profile is, for example, by matching the profiling results with the background of each source code line and displaying the profiling results in the form of graphical bars.

According to an embodiment of the present invention, the profiling results as mentioned will reveal for example, the number of total program execution, the ratio of the program execution to total executions and the system resources consumed during each execution. Based on the numerical results, the length of the bars can be calculated by a logarithm or normalization method, and the graphical bars are displayed on the background of corresponding source code lines.

The present invention offers a method for displaying the profiling results in a software development environment, the method comprising executing one program code in a software development environment to generate a corresponding profile. According to the contents of the profile, the partial execution result is displayed in the form of a graphical figure in a portion of the corresponding program code. This graphical figure is visually displayed in reference to the profiling results of the partially executed program code, for determining the executing result. The present invention also provides the software development program that displays the profiles as mentioned.

The present invention offers a method for displaying the profiling results in a software development environment and a software development program with such profiling display. The viewing properties of the profile should include for example, a ruler for measuring the range of the graphical bars and a computation principle that scales the ruler.

According to an embodiment of the present invention, the position of the ruler-assisted viewing feature could be at the top or bottom of the editing window. The readings of the ruler could be expressed for example, by the number of times the program is executed, relative frequency of the program execution and the distribution of system resources consumed during each program execution. After proper calculations by a logarithm or normalization method, the scales of the ruler are then labeled with appropriate units.

In accordance with the above mentioned, the present invention provides a new visual presentation method, which is capable of graphically showing the numerical results of the profile in the source code editing window of an integrated developing environment. This offers programmers a more efficient and intuitive way to tune the source code. Furthermore, the source code editing window includes a ruler that measures the range of the graphical bars and different aspects of the profiling results can be interpreted into proper scaling of the ruler. Therefore, the programmers can avoid shifting between programs and sense the profiling results by intuition.

The above and other features of the present invention will be better understood from the following detailed description of the embodiments of the invention that is provided in communication with the accompanying drawings.

### BRIEF DESCRIPTION OF THE DRAWINGS

FIG. 1 is a flowchart showing the method of accessing the profiling data in a software development environment according to one embodiment of the present invention.

FIG. 2 is a schematic drawing showing the method of accessing the profiling data in a software development environment according to one embodiment of the present invention.

FIG. 3 is a schematic drawing showing the viewing of the profiling data in a software development environment according to one embodiment of the present invention.

### DESCRIPTION OF SOME EMBODIMENTS

Due to the fact that viewing profiling results in a conventional software development system is neither intuitive nor expedient, the present invention proposes a new visual presentation method which graphically illustrates the profiling results in the source code editor of the integrated software development environment. This allows illustration of frequency, time or any other aspects of the profiling results to be shown in a variety of units. Additionally, the present invention can avoid the drawback of switching between different programs or the non-intuitive numerals representation of profiling results. Further, a programmer can view the executing results of a program running in a compiler in a quick and simple manner and locate the hotspot right away, no matter it is the part where the most executing time is consumed or the part where the execution number looks unusual. By referring to these results, the source code can be tuned efficiently.

The present invention provides a method for displaying profiling data in a software development environment and the software development program with such profiling display, such that profiling results are visually illustrated in the source code editing window in the software development environment. In one embodiment, the display method proposed in the present invention is adapted for a source code programming based software development environment. The method of accessing the profiling data is, for example, by allowing the profiling results to be graphically shown on the background of the corresponding source code lines. In another embodiment, the graphically displayed results can be in the form of graphical bars which represent corresponding numerical results of the respective profiles after the program execution. In still another embodiment, this graphic display method could further include a ruler located in the source code editing window in the software development environment for range-reading interpretations of the graphical bars, making the viewing process of the profiling results of each corresponding line easier and more convenient.

In all embodiments of this invention, the profiling results mentioned above include for example, total execution number of the program, the ratio of the program on total executions, and the distribution of system resources consumption during program execution. According to the numerical results, the length of the bars is measured by either ae logarithm or normalization method, and then the graphical bar is displayed on the background of each corresponding source code line.

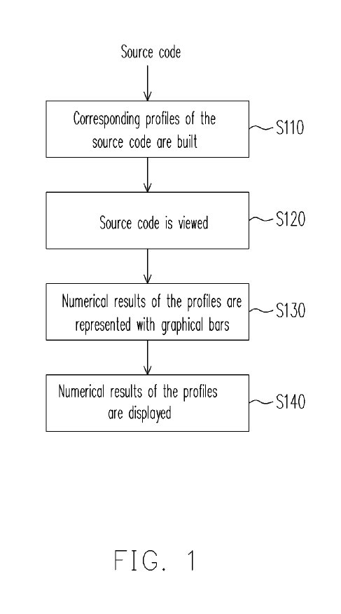

FIG. 1 is a flowchart showing the method of accessing the profiling data in a software development environment according to one embodiment of the present invention. Referring to FIG. 1, first, the source code in the software development environment is edited, and then the corresponding profiling data of the source code is built in step S110. Next, the source code is directly viewed in step S120. In step S130, the profiling results are then represented in the form of graphical bars, for example. In the last step S140, the profiling results are displayed.

In step S110, the software development environment may use external profiling programs, software stimulators or hardware support, to acquire profiling results. Additionally, the software development environment can also utilize the debugging features of application programs, combined with the profiling results, to generate corresponding profiling data of the source code. The profiling results and corresponding profiling data include, for example, total number of times the program is executed, ratio of program executions to total executions and the system resources distribution during the program executions.

In step S120, when viewing the source code placed in the editing window, the source code to be viewed must be processed in the source code editor in the software development environment. The source code editor will refer to the corresponding relationships between the source code and the profiles built in step S110 to match the corresponding information.

In step S130, the length of the graphical bar is based on the corresponding information of the source code and the profiling results, and the corresponding length of the graphical bar is calculated by either a logarithm or normalization method. For example, if graphical bars are displayed in the embodiment, profiling results are configured to the length of the graphical bars in order to represent program executions, ratio of program executions to total executions and the system resources distribution during the program executions, and finally have them properly shown in each corresponding source code line.

In step S140, graphical bars that represent the source code lines are shown for instance, in different colors and displayed directly in the background of each corresponding line in a translucent fashion. The length of the graphical bars is derived from the numerical values mentioned above, which is calculated by either a logarithm or normalization method to obtain the corresponding scale of the graphical figures. Furthermore, in another embodiment, the graphical display of the source code editor can also include a ruler that reads the range of the graphical bars to help view the corresponding values of the profiling results.

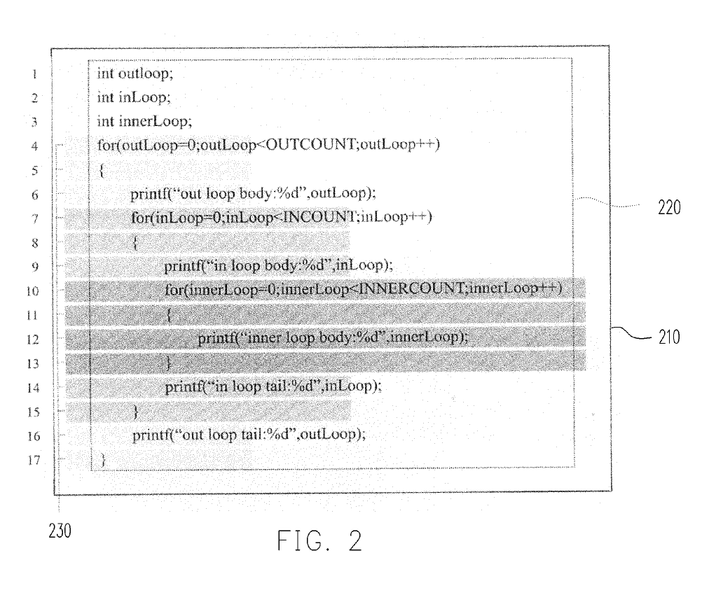

In order to understand the essence of the present invention, an embodiment is shown in FIG. 2. FIG. 2 is a schematic drawing showing the method of accessing the profiling data in a software development environment according to one embodiment of the present invention. Referring to FIG. 2, the source code editing window 210 is utilized for source code editing and the display of profiling results in the window. Graphical bars 230 are illustrated in different lengths in the source code editing window 210 based on the source code 220 and its corresponding profiling results. The information that the graphical bars 230 represent includes, for example, the total number of program executions, the ratio of program executions to total executions and the system resources distribution during the program executions, and according to the calculation of the numerical results by a logarithm or normalization method, the length of the graphical bars 230 is calculated and displayed in the background of each corresponding source code line 220. Due to the fact that the 1 st to the 3rd program code lines are for declaring parameters in the source code 220, no profiling results would correspond to these lines. As a result, the 1st to the 3rd program code lines would not have graphical bars in their background.

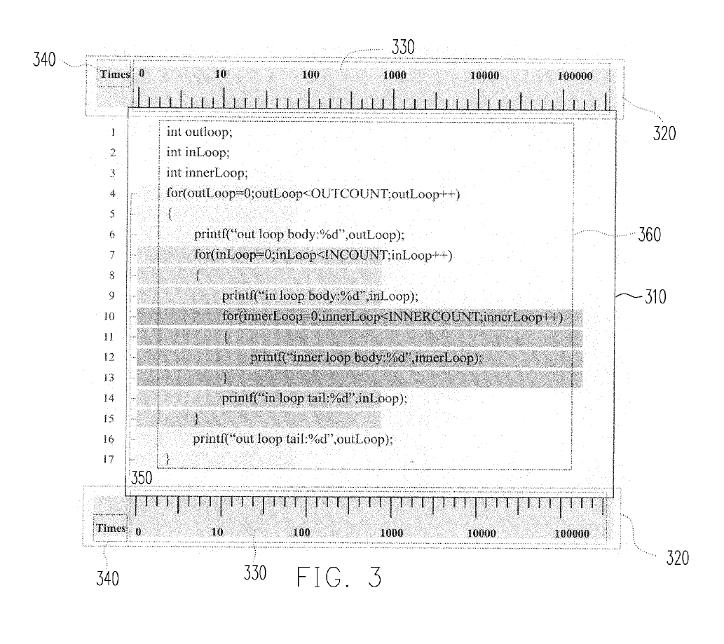

FIG. 3 is a schematic drawing showing the viewing of the profiling data in a software development environment according to one embodiment of the present invention. Referring to FIG. 3, two rulers 320 are located at the top and bottom of the source code editing window 310, respectively, for reading the range of graphical bars 350 in the source code editing window. Each ruler may, for example, include a scale 330, and further include the corresponding scale unit 340. In an embodiment, the scale unit 340 of the scale 330 may be represented by the number of times the program is executed, for example. In addition, the scale unit 340 may also be expressed by the ratio of the program executions or the distribution of system resources during the program executions.

Additionally, the foresaid scale unit 340 is also related to the corresponding data between the source code and the profile in step S110 of FIG. 1. For example, when the corresponding data created from the source code and profile are represented by the number of times the program is executed, the source code editing window 310 will start referring to the program execution results to calculate the value of each source code line after switching to the source code editing window. Then, the scale 330 of the ruler 320 is labeled by either logarithm or normalization method. In the meantime, the ruler 320 is labeled with the scale unit 340 which shows the number of times the program is executed.

According to the above, the 4th to the 6th lines and the 16th to the 17th lines of the program segments of the source code 360 have bar graphs with the same range. In this embodiment, the top and bottom rulers 320 of the source code editing window can guide the user to read the number of execution in a particular program segment (around 90 times) in an easy and intuitive way. Similarly, the number of executions in the program segments of the 7th to the 9th lines, the 14th to the 15th lines and the 110th to the 13th lines are also shown.

In an embodiment of the present invention, a software development program which displays profiling results is provided. The software development program comprises a storage module and a display module. The storage module is utilized for saving a program code that is temporarily executed in a software development environment for generating corresponding profiles. According to the contents of the profile, the display module displays the partial execution result in the form of a graphical figure in a portion of the corresponding program code. This graphical figure is visually displayed in reference to the profiling results of the partially executed program code, for determining the executing result.

As a result, this software development program with the profiling display can graphically display numerical results of the profile in the source code editing window in the software development environment. In one embodiment of the present invention, the method of accessing the profile display data in a software development program is for example, by displaying the numerical results of the profiles in the background of each corresponding source code line, and showing corresponding graphical figures of numerical results of the profiles. In one embodiment, the display method is by showing corresponding numerical results of the profiles in graphical bars after the program executions. Furthermore, in another embodiment, the display is presented in a source code editing window in a software development environment, in which the software development environment may include a ruler that assists the reading of the range of graphical bars such that corresponding numerical values of the profiling results can be viewed in an intuitive way. The numerical results of the profiles mentioned above may include, for example, the total number of times the program is executed, the ratio of program executions to total executions and the system resources distribution during the program executions, and by calculating the numerical results by a logarithm or normalization method, the length of the graphical bars is obtained and displayed in the background of each corresponding source code line.

According to the above-mentioned, the present invention has at least the following advantages.

1. Due to the fact that the profile analysis program of the present invention is directly integrated in the debugging or developing environment and is capable of showing the analytical results such as the number of times the program is executed and time information in the form of graphical bars on the background of each corresponding program code line, users can detect inappropriate program segments by intuition and tune the source code directly and efficiently.

2. The software development environment of the present invention includes a ruler that facilitates the viewing, so the numerical results of the profile (within the range of the graphical bars) could be recognized in an intuitive way while the program codes are rapidly scrolled. This is quite different from the conventional method of displaying profiling results in the form of numerals in the beginning of each source code line. Also, the present invention can save the effort of determining the magnitude of numerals in a vast amount of source codes.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A method for displaying profiles in a software development environment, the method comprising:
executing one program code in a software development environment to generate a corresponding profile; and
displaying a partial execution result in the form of a graphical figure in a portion of the corresponding program code according to the contents of the profile, the graphical figure being visually displayed in reference to the partial profiling results of the partially executed program code, for determining the executing result.

2. The method for displaying profiles in a software development environment according to claim 1, wherein the method of displaying the graphical figure of the partial execution result of the program code is by using a graphical bar in translucent color shown in the background of a source code in the software development environment.

3. The method for displaying profiles in a software development environment according to claim 2, wherein when the partial execution result of the program code is represented by the graphical bar, the length of the bar indicates the size of the contents of the profile after the program code is executed.

4. The method for displaying profiles in a software development environment according to claim 2, wherein when the partial execution result of the program code is represented by the graphical bar, the color of the bar indicates the size of the contents of the profile after the program code is executed.

5. The method for displaying profiles in a software development environment according to claim 1, wherein a numerical result of the profile is obtained according to the number of times the corresponding source code is executed in the software development environment.

6. The method for displaying profiles in a software development environment according to claim 5, wherein a corresponding scale of the graphical figure is based on calculating the number of times the partial program code is executed by a logarithmic method.

7. The method for displaying profiles in a software development environment according to claim 5, wherein a corresponding scale of the graphical figure is based on calculating the number of times the partial program code is executed by a normalization method.

8. The method for displaying profiles in a software development environment according to claim 1, wherein a numerical result of the profile is obtained according to the ratio of the number of times the corresponding source code is executed in the software development environment to total executions.

9. The method for displaying profiles in a software development environment according to claim 8, wherein a corresponding scale of the graphical figure displayed is based on calculating the ratio of the number of times the program code is executed to total executions by a logarithmic method.

10. The method for displaying profiles in a software development environment according to claim 8, wherein a corresponding scale of the graphical figure displayed is based on calculating the ratio of the number of times the program code is executed to total executions by a normalization method.

11. The method for displaying profiles in a software development environment according to claim 1, wherein a numerical result of the profile is obtained according to the ratio of the number of times the corresponding source code is executed in the software development environment to the system resources consumed for executing the program code.

12. The method for displaying profiles in a software development environment according to claim 11, wherein a corresponding scale of the graphical figure is based on calculating the ratio of the number of times the source code is executed to the system resources consumed for executing the program code by a logarithmic method.

13. The method for displaying profiles in a software development environment according to claim 11, wherein a corresponding scale of the graphical figure is based on calculating the ratio of the number of times the source code is executed to the system resources consumed for executing the program code, by a normalization method.

14. The method for displaying profiles in a software development environment according to claim 2, wherein when the partial execution result of the program code is represented by the graphical bar, a ruler is further added in the software development environment to view the length of the graphical bar.

15. A software development program with profiling display, comprising:
a storage module, for temporarily storing a program code executed in the software development environment to generate a corresponding profile; and
a display module, displaying a partial execution result in the form of a graphical figure in a portion of the corresponding program code according to the contents of the profile, the graphical figure being visually displayed in reference to the profiling results of the partially executed program code, for determining the executing result.

16. The software development program with profiling display of claim 15, wherein the method of displaying the graphical figure of the partial execution result of the program code is by using a graphical bar in a translucent color in the background of a source code in the software development environment.

17. The software development program with profiling display of claim 16, wherein when the partial execution result of the program code is represented with the graphical bar, the length of the graphical bar indicates the size of the contents of the profile after the program code is executed.

18. The software development program with profiling display of claim 16, wherein when the partial execution result of the program code is represented with the graphical bar, the color of the graphical bar indicates the size of the contents of the profile after the program code is executed.

19. The software development program with profiling display of claim 15, wherein a numerical result of the profile is obtained according to the number of times the corresponding source code of the software development environment is executed.

20. The software development program with profiling display of claim 19, wherein a corresponding scale of the graphical figure is based on calculating the number of times the partial program code is executed by a logarithmic method.

21. The software development program with profiling display of claim 19, wherein a corresponding scale of the graphical figure is based on calculating the number of times the partial program code is executed by a normalization method.

22. The software development program with profiling display of claim 15, wherein a numerical result of the profile is obtained according to the ratio of the number of times the corresponding source code is executed in the software development environment to total executions.

23. The software development program with profiling display of claim 22, wherein a corresponding scale of the graphical figure is based on calculating the ratio of the number of times the program code is executed to total executions by a logarithmic method.

24. The software development program with profiling display of claim 22, wherein a corresponding scale of the graphical figure is based on calculating the ratio of the number of times the program code is executed to total executions by a normalization method.

25. The software development program with profiling display of claim 15, wherein a numerical result of the profile is obtained according to the ratio of the number of times the corresponding portion of source code in the software development environment is executed to the system resources consumed for executing the program code.

26. The software development program with profiling display of claim 25, wherein a corresponding scale of the graphical figure is based on calculating the ratio of the number of times the source code is executed to the system resources consumed for executing the program code, by a logarithmic method.

27. The software development program with profiling display of claim 25, wherein a corresponding scale of the graphical figure is based on calculating the ratio of the number of times the source code is executed to the system resources consumed for executing the program code by a normalization method.

28. The software development program with profiling display of claim 16, wherein when the partial execution result of the program code is represented with the graphical bar, a ruler is further added in the software development environment for viewing the length of the graphical bar.

29. A physical storage medium device, for storing a software development program with profiling display of claim 15.
